(19) United States
(12) Patent Application Publication
(10) Pub. No.: US 2020/0304933 A1
(43) Pub. Date: Sep. 24, 2020

(54) SOUND PROCESSING SYSTEM OF AMBISONIC FORMAT AND SOUND PROCESSING METHOD OF AMBISONIC FORMAT

(71) Applicant: HTC Corporation, Taoyuan City (TW)

(72) Inventors: Yu-Ying LIEN, Taoyuan City (TW); Shu-Hung TSENG, Taoyuan City (TW); Yao SHIAO, Taoyuan City (TW)

(73) Assignee: HTC Corporation, Taoyuan City (TW)

(21) Appl. No.: 16/358,235

(22) Filed: Mar. 19, 2019

(51) Int. Cl. H04S 5/00; H04R 1/40

(52) U.S. Cl. CPC H04S 5/00; H04S 2420/11; H04R 1/406

(57) ABSTRACT

A sound processing method includes the following steps: obtaining first audio data of a specific object that corresponds to a first position; when the specific object moves to a second position, calculating movement information of the specific object according to the first position and the second position; searching a space transfer database for a space transfer function that corresponds to the movement information; and applying the space transfer function to the first audio data, so that the specific object generates a sound output that corresponds to the second position.

### BACKGROUND OF THE INVENTION

### Field of the Invention

The present disclosure relates to a processing system and, in particular, to a sound processing system of ambisonic format and a sound processing method of ambisonic format.

### Description of the Related Art

At present, the sound experience provided in virtual reality is in the form of object-based audio to achieve a “six degrees of freedom” experience. The six degrees of freedom are movement in the direction of the three orthogonal axes of x, y, and z, and the degrees of freedom of rotation of the three axes. This method arranges each sound source in space and renders it in real time. It is mostly used for film and game post-production. Such sound effects need to have the metadata of the sound source, the position, size and speed of the sound source, and the environmental information, such as reverberation, echo, attenuation, etc., that requires a large amount of information and operations, and is reconciled through post-production. However, when a general user records a movie in a real environment, all the sounds such as the environment and the target object are recorded. It cannot independently obtain information about the sound source of each of the objects without any limitation in the environment, so object-oriented sound effects are difficult to implement.

Therefore, how to allow a general user with limited resources to record the actual environment of a movie for the purposes of making a virtual reality movie is a problem that needs to be solved. In a virtual reality video, there is another problem to be solved, in that in a field in which walking in simulated, which may be close to or far away from the sound source of virtual objects, needs to be adjusted according to the user's walking, so that the user is more immersed in the environment recorded by the recorder.

### BRIEF SUMMARY OF THE INVENTION

In accordance with one feature of the present invention, the present disclosure provides a sound processing method. The sound processing method is suitable for application in ambisonic format. The sound processing method comprises: obtaining first audio data of a specific object corresponding to a first position; when the specific object moves to a second position, calculating movement information of the specific object according to the first position and the second position; searching a space transfer database for a space transfer function that corresponds to the movement information; and applying the space transfer function to the first audio data, so that the specific object generates a sound output that corresponds to the second position.

In accordance with one feature of the present invention, the present disclosure provides a sound processing system, suitable for application in ambisonic format. The sound processing system comprises a storage device and a processor. The storage device stores a space transfer database. The processor obtains first audio data of a specific object corresponding to a first position, and when the specific object moves to a second position, the processor calculates the movement information of the specific object according to the first position and the second position, searches for a space transfer function that corresponds to the movement information in the space transfer database, applies the space transfer function to the first audio data, and generates a sound output that corresponds to the second position.

The embodiment of the present invention provides a sound processing system and a sound processing method, so that the user can further simulate the walking position in the movie in the virtual reality. In addition, the user can rotate his head to feel the sound orientation and the source of sound that is close to or far from the virtual object, allowing the user to become more deeply immersed in the environment recorded by the recorder. In other words, the sound processing system and the sound processing method of the embodiments of the present invention can use the movement of the user to adjust the sound and allow the user to walk freely in virtual reality when a virtual reality movie is played back. The user can hear the sound being adjusted automatically with the walking direction, distance, and head rotation. The sound processing system and the sound processing method do not need to record the information of each object in the movie when recording a virtual reality movie. This reduces the difficulty faced by a general user when recording an actual environment for a virtual video film.

### BRIEF DESCRIPTION OF THE DRAWINGS

The invention can be more fully understood by reading the subsequent detailed description and examples with references made to the accompanying drawings, wherein:

FIG. 1 is a block diagram of a sound processing system accordance with one embodiment of the present disclosure.

FIG. 2 is a schematic diagram of a method for generating a space transfer function in accordance with one embodiment of the present disclosure.

FIG. 3 is a flowchart of a sound processing method 300 in accordance with one embodiment of the present disclosure.

FIGS. 4A-4B are schematic diagrams of a sound processing method in accordance with one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “comprises” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

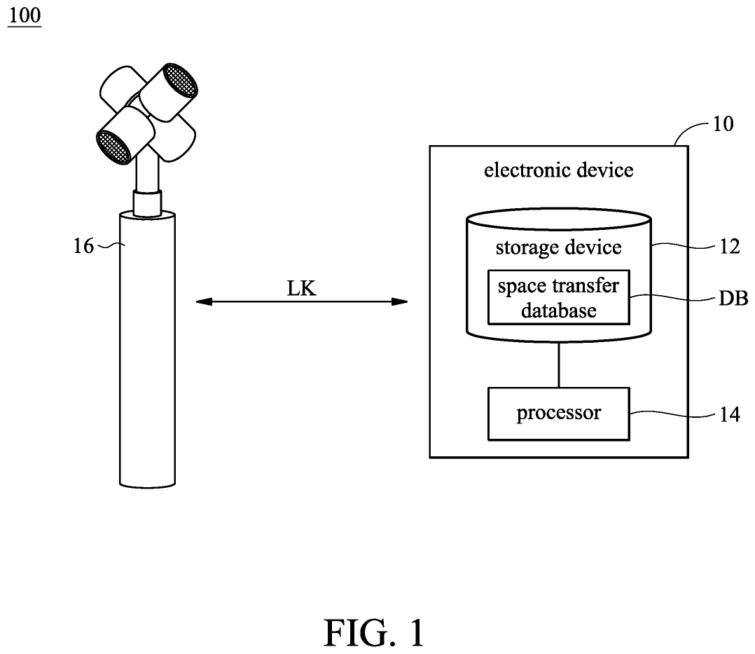

Please refer to FIG. 1, FIG. 1 is a schematic diagram of a sound processing system 100 in accordance with one embodiment of the present disclosure. In one embodiment, the sound processing system 100 can be applied to a sound experience portion of a virtual reality system. In one embodiment, the sound processing system 100 includes a storage device 12, a microphone array 16 and a processor 14. In one embodiment, the storage device 12 and the processor 14 are included in an electronic device 10. In one embodiment, the microphone array 16 can be integrated into the electronic device 10. The electronic device 10 can be a computer, a portable device, a server or other device having calculation function component.

In one embodiment, a communication link LK is established between the electronic device 10 and the microphone array 16. The microphone array 16 is configured to receive sound. The microphone array 16 transmits the sound to the electronic device 10.

In one embodiment, the storage device 12 can be implemented as a read-only memory, a flash memory, a floppy disk, a hard disk, a compact disk, a flash drive, a tape, a network accessible database, or as a storage medium that can be easily considered by those skilled in the art to have the same function. In one embodiment, the storage device 12 is configured to store a space transfer database DB.

In one embodiment, the surround sound film recorded by a general user may be based on a high fidelity surround sound (Ambisonic) format, which is also referred to as high fidelity stereo image copying. This method is to present the ambient sound on the preset spherical surface during the recording, including the energy distribution in the axial direction. The direction includes up and down, left and right, and front and rear of the user. This method has previously rendered the sound information to a fixed radius sphere. In this way, the user can experience the variation of the three degrees of freedom (the rotational degrees of freedom in the three orthogonal coordinate axes of x, y, and z), that is, the change in the sound orientation produced by the rotating head. However, this method does not consider the information on the distance variation. As such, the user cannot feel the change of six degrees of freedom. In this case, the following method that can solve this problem is proposed and can be applied to sound effects in a scene used by a virtual movie.

In one embodiment, the microphone array 16 includes a plurality of microphones for receiving sound. In one embodiment, the more dominant format of the sound used in the virtual reality movie is called the high fidelity surround sound (Ambisonic) format, which is a spherical omnidirectional surround sound technology, mostly using four direction of sound field microphones. The audio in the virtual reality film is recorded in at least four independent recording tracks, and the four independent recording tracks record the X channel data (usually represented by the symbol X), Y channel data (usually represented by the symbol Y), Z channel data (usually represented by the symbol Z), and omnidirectional channel data (usually represented by the symbol W). In one embodiment, the microphone array 16 can be used to record audio data at a plurality of positions, such as the microphone array 16 recording first audio data at a first position.

In one embodiment, the processer 14 can be any electronic device having a calculation function. The processer 14 can be implemented using an integrated circuit, such as a microcontroller, a microprocessor, a digital signal processor, an application specific integrated circuit (ASIC), or a logic circuit.

In one embodiment, the sound processing system 100 can be applied to a virtual reality system. The sound processing system 100 can output sound effects to correspond to the position of the user at each time point. For example, when the user slowly approaches a sound source in virtual reality, the sound source is adjusted more and more loudly as the user approaches. In contrast, when the user slowly moves away from the sound source in virtual reality, the sound source is adjusted to become quieter and quieter as the user moves away.

In one embodiment, the virtual reality system can apply known technology to determine the user's position, so it will not be described here. In one embodiment, this is performed via the head-mounted display that a user usually wears when viewing a virtual reality movie. The head-mounted display may include a g-sensor for detecting the rotation of a user's head. The rotation information of the user's head includes the rotation information on the X-axis, the Y-axis, and the Z-axis. The rotation information measured by the head-mounted displays is transmitted to the electronic device 10. Therefore, the processor 14 in the electronic device 10 of the sound processing system 100 can output the sound effects according to information about the user's movement (such as applying known positioning technology to determine the distance that the user has moved) and/or about the user's head rotation (such as applying a gravity sensor in a head-mounted display to get rotation information). In this way, in addition to turning his head to hear the sound orientation, the user can virtually walk in the virtual reality film, approaching or moving away from the sound source, and become more immersed in the environment recorded by the recorder.

In one embodiment, the processor 14 of the sound processing system 100 regards the amount of change of the sound signal caused by the distance from the sound source as a filtering system, including volume change, phase change, and frequency change, and the like, caused by the movement. The processor 14 quantifies the audio differences caused by the distance changes and applies them to the audio files of the listener's original virtual reality film, the listener can experience the feeling of approaching/away from the sound source in real time. This is described in more detail below.

In one embodiment, the processor 14 obtains first audio data of a specific object corresponding to a first position. For example, the specific object (e.g., the user or an electronic device) is initially located at the first position. When the specific object moves to a second position, the processor 14 calculates movement information (for example, the distance between the first position and the second position) of the specific object according to the first position and the second position. The processor 14 searches through the space transfer database DB to find a space transfer function that corresponds to the movement information, and applies the space transfer function to the first audio data, so that the specific object generates a sound output that corresponds to the second position.

In one embodiment, the multiple space transfer functions may be stored in the space transfer database DB in advance for subsequent acquisition and application in the sound processing method 300. The manner in which the space transfer function is generated is explained below.

In one embodiment, in an unvoiced chamber (or a muffler chamber, an anechoic chamber), given an impulse response at a distance between different azimuth angles, and the microphone array 16 is used for radio reception, the four-channel data of the high fidelity surround sound format can be obtained. The processor 14 can obtain the frequency domain change information of four channels at different distances from each corner by inputting the four-channel data through the Fourier transform. The frequency domain change information is the space transfer function. In one embodiment, the microphone array 16 can be a microphone array with high fidelity surround sound standards. The following is a more detailed description of the manner in which the space transfer function is generated.

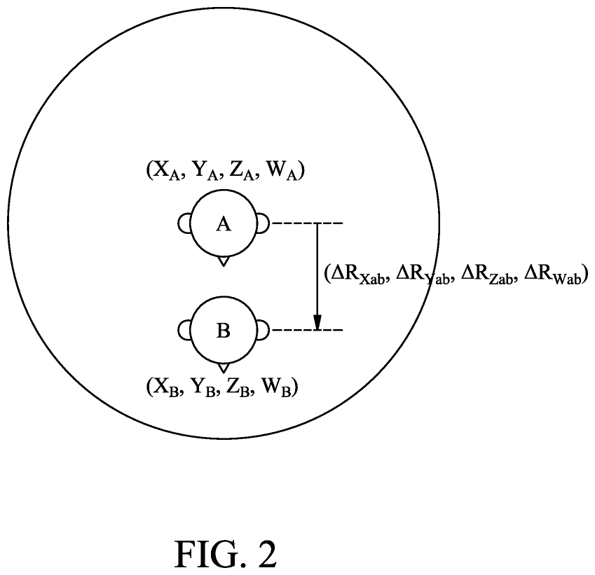

Referring to FIG. 2, FIG. 2 is a schematic diagram of a method for generating a space transfer function in accordance with one embodiment of the present disclosure. In an embodiment, as shown in FIG. 2, after the microphone array 16 records the audio data (X_{A}, Y_{A}, Z_{A}, W_{A}) at the position A, it moves to the position B to record the audio data (X_{B}, Y_{B}, Z_{B}, W_{B}). The processor 14 calculates the amount of change of each parameter value of the audio data (X_{A}, Y_{A}, Z_{A}, W_{A}) and the audio data (X_{B}, Y_{B}, Z_{B}, W_{B}), and calculates the movement information of the position A and the position B (for example, the moving distance from the position A to the position B is 2 meters). According to the variation of these parameter values, the space transfer function (ΔR_{Xab}, ΔR_{Yab}, ΔR_{Zab}, ΔR_{Wab}) corresponding to the movement information is generated, and the space transfer function (ΔR_{Xab}, ΔR_{Yab}, ΔR_{Zab}, ΔR_{Wab}) is generated and stored in the space transfer database DB.

In one embodiment, the audio data (X_{A}, Y_{A}, Z_{A}, W_{A}) includes X channel data X_{A}, Y channel data Y_{A}, Z channel data Z_{A}, and omnidirectional channel data W_{A}. The audio data (X_{B}, Y_{B}, Z_{B}, W_{B}) contains X channel data X_{B}, Y channel data Y_{B}, Z channel data Z_{B} and omnidirectional channel data W_{B}.

In one embodiment, the variation of the parameter values includes the difference variation ΔR_{Xab} between the X channel data X_{A} and the X channel data X_{B}, the difference variation ΔR_{Yab} between the Y channel data Y_{A} and the Y channel data Y_{B}, and the difference ΔR_{Zab} between the Z channel data Z_{A} and the Z channel data Z_{B} and the difference ΔR_{wab} between the omnidirectional channel data W_{A} and the omnidirectional channel data W_{B}.

In one embodiment, the method for obtaining the space transfer function described in FIG. 2 can be repeated and performed in a large amount, and the microphone array 16 is disposed at various positions in a specific space, so that the processor 14 obtains the parameter value change amount of each relative position to generate a large number of space transfer functions, and stores the space transfer functions in the space transfer database DB. Therefore, the space transfer functions in the space transfer database DB can be subsequently applied. As such, more accurate information can be obtained when the space transfer function is used.

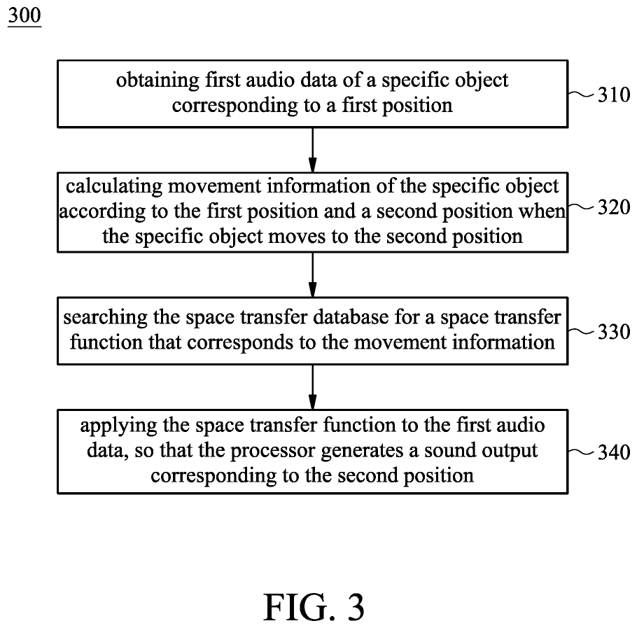

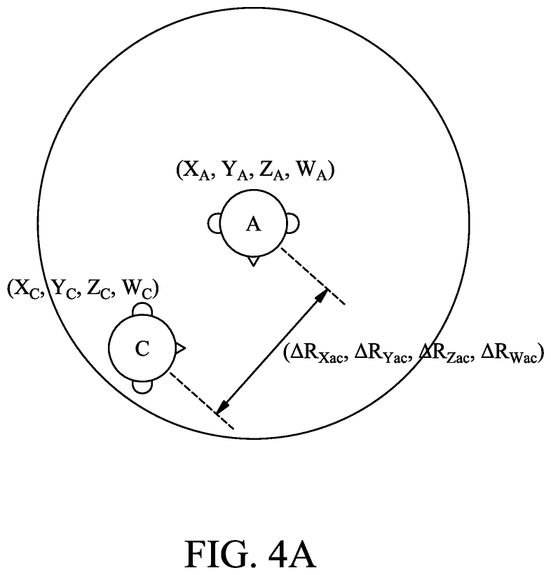

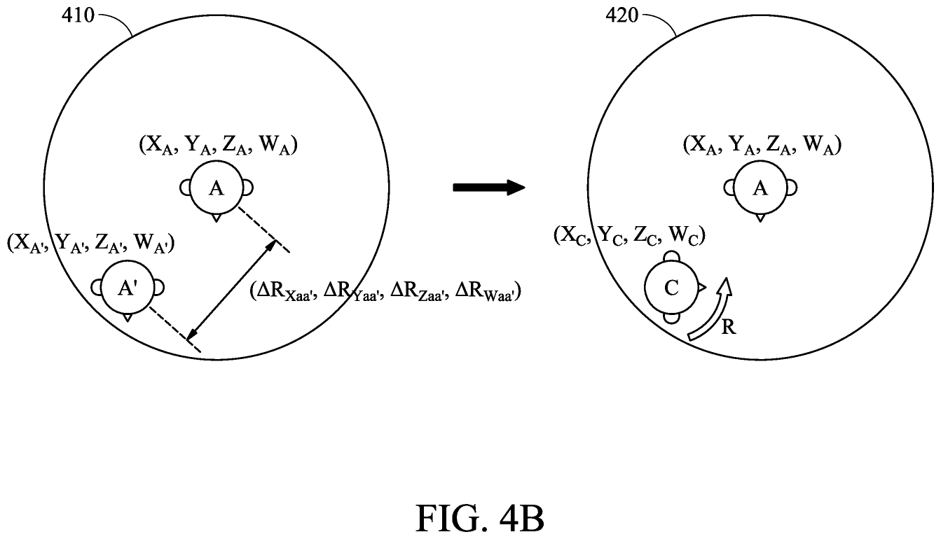

Referring to FIGS. 3, 4A and 4B, FIG. 3 is a flowchart of a sound processing method 300 in accordance with one embodiment of the present disclosure. FIGS. 4A-4B are schematic diagrams of a sound processing method in accordance with one embodiment of the present disclosure.

In step 310, the processor 14 obtains first audio data of a specific object corresponding to a first position. The first position refers to the position of a particular object (e.g., a user or an electronic device). In one embodiment, the position of the user can be obtained by a positioning technique known in the art of virtual reality.

In one embodiment, as shown in FIG. 4A, after the processor 14 determines that the position of a specific object (for example, an electronic device worn by a user) is located at the position A, the processor 14 reads the audio data (X_{A}, Y_{A}, Z_{A}, W_{A}) corresponding to position A from the space transfer database DB. In one embodiment, the position of the user can be obtained using a known head tracking method, and thus it will not be described here. In one embodiment, the user can wear a head mounted display. The virtual reality system can determine the position of the head mounted display using known algorithms to track the position of the user's head.

However, the present invention is not limited thereto. The processor 14 can determine the position of the movement of any particular object (for example, other electronic devices and/or body parts) in a specific area (such as the specific area 410 of FIG. 4B) and its movement information. The processor 14 performs following steps.

In step 320, the processor 14 calculates movement information of the specific object according to the first position and a second position when the specific object moves to the second position. For example, as shown in FIG. 4A, when a particular object (e.g., an electronic device worn by a user) moves to position C, processor 14 calculates movement information of position A and position C (e.g., the moving distance from position A to position C is 2 meter). The second position refers to the position of a specific object. The relationship between the first position and the second position corresponds to a space transfer function (ΔR_{Xac}, ΔR_{Yac}, ΔR_{Zac}, ΔR_{Wac}) of the movement information. In one embodiment, the position of the user can be obtained by a positioning technique known in the art of virtual reality.

In the example shown in FIGS. 4A-4B, a specific object moves to a position A′ (as shown by the specific space 410 in FIG. 4B), and then rotates to a position C in the direction R (e.g., as shown in the specific space 420 in FIG. 4B).

In step 330, the processor 14 searches the space transfer database DB for a space transfer function that corresponds to the movement information. For example, as shown in FIG. 4B, when a specific object moves from position A to position A′, processor 14 calculates that the moving distance of position A from position A′ is 2 meters. The processor 14 searches through the space transfer database DB for the space transfer function that corresponds to a moving distance of 2 meters (ΔR_{Xaa′}, ΔR_{Yaa′}, ΔR_{Zaa′}, ΔR_{Waa′}). The generating process of the space transfer function is as shown in FIG. 2 with its description. Therefore, it is not described here.

In step 340, the processor 14 applies the space transfer function (ΔR_{Xaa′}, ΔR_{Yaa′}, ΔR_{Zaa′}, ΔR_{Waa′}) to the first audio data (X_{A}, Y_{A}, Z_{A}, W_{A}), so that the processor 14 generates a sound output corresponding to the second position.

In one embodiment, the processor 14 applies a space transfer function (ΔR_{Xaa′}, ΔR_{Yaa′}, ΔR_{Zaa′}, ΔR_{Waa′}) to the audio data (X_{A} , Y_{A}, Z_{A}, w_{A}) to produce a space transfer function (X_{A}+ΔR_{Xaa′}, Y_{A}+ΔR_{Yaa′}, Z_{A}+ΔR_{Zaa′}, W_{A}+ΔR_{Waa′}) of position A′. The processor 14 searches the space transfer database DB for the output sound of the space transfer function (X_{A}+ΔR_{Xaa′}, Y_{A}+ΔR_{Yaa′}, Z_{A}+ΔR_{Zaa′}, W_{A}+ΔR_{Waa′}) corresponding to the position A′.

In one embodiment, the processor 14 applies a space transfer function (X_{A}+ΔR_{Xaa′}, Y_{A}+ΔR_{Yaa′}, Z_{A}+ΔR_{Zaa′}, W_{A}+ΔR_{Waa′}) to the audio data (X_{A}, Y_{A}, Z_{A}, W_{A}), and adjusts the phase, the volume or the frequency of the first audio data to produce an output sound that corresponds to the second position of a specific object.

In one embodiment, if there is no space transfer function corresponding to the movement information (for example, moving from position A to position A′) in the space transfer database DB, the processor 14 may select multiple space transfer functions close to the movement information. The space transfer function that approximates this movement information is calculated according to these close space transfer functions by means of interpolation or other known algorithms.

Accordingly, when the sound processing method 300 is applied to the virtual reality system, the output sound corresponding to the specific object at the position A is not the same as the output sound corresponding to the position A′. In other words, effect of the output sound can correspond to the position of a specific object. The space transfer function is applied for adjustment of frequency, phase, and/or volume.

In one embodiment, as shown in the specific space 420 of FIG. 4B, when a specific object moves to the position A′, the direction R of the specific object is further rotated to the position C (shown as in the specific space 420 of FIG. 4B). The processor 14 can take this rotation variable by a gravity sensor (g-sensor) wearing by a specific object and apply a known algorithm, such as a quaternion, Euler angle, rotation matrix, rotation vector (Euclidean vector) and other common three-dimensional rotation methods, etc., applied to audio data (X_{C}, Y_{C}, Z_{C}, W_{C}) to produce an output sound to get the sense of hearing at position C.

In one embodiment, when the processor 10 applies the sound processing method 300 to the virtual reality system and the 360-degree virtual reality movie recorded by another person is played on the virtual reality system, the head-mounted display worn by the user can move through virtual reality movies and allow the user to experience sound effects close to or far from the sound source.

In one embodiment, by applying the sound processing method 300, when a pre-recorded virtual reality movie is played on the handheld device, the output sound effects can be enhanced or attenuated for the regional orientation of interest.

In summary, the embodiment of the present invention provides a sound processing system and a sound processing method, so that the user can further simulate the walking position in the movie in the virtual reality. In addition, the user can rotate his head to feel the sound orientation and the source of sound that is close to or far from the virtual object, allowing him to become more deeply immersed in the environment recorded by the recorder. In other words, the sound processing system and the sound processing method of the embodiments of the present invention can use the movement of the user to adjust the sound and allow the user to walk freely in virtual reality when the virtual reality movie is played back. The user can also hear the sound adjusted automatically with the walking direction, distance, and head rotation. The sound processing system and the sound processing method do not need to record the information of each object in the movie when recording the virtual reality movie. It reduces the difficulty for a general user to record a virtual video film in an actual environment.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

1. A sound processing system, suitable for application in ambisonic format, comprising:
a storage device, configured to store a space transfer database;
a processor, configured to
obtain first audio data of a specific object corresponding to a first position,
when the specific object moves to a second position, calculate movement information of the specific object according to the first position and the second position,
generate a space transfer function corresponding to the movement information, and
store the space transfer function to the space transfer database.

2. The sound processing system of claim 1, further comprising:
a microphone array, configured to record the first audio data in the first position;
wherein the first audio data includes first X channel data, first Y channel data, first Z channel data, and a first W channel data, and the movement information includes a moving distance or a coordinate position.

3. The sound processing system of claim 1, wherein
the processor is further configured to search the space transfer database for a space transfer function that corresponds to the movement information, apply the space transfer function to the first audio data, and generate a sound output corresponding to the second position,
after the processor applies the space transfer function to the first audio data, the processor adjusts phase, loudness or frequency of the first audio data to generate the sound output of the specific object that corresponds to the second position.

4. The sound processing system of claim 2, wherein after recording the first audio data in the first position, the microphone array moves to the second position to record a second audio data, the processor calculates a plurality of parameter variations of the first audio data and the second audio data, calculates the movement information of the first position and the second position, and generate the space transfer function corresponding to the movement information according to the parameter variations, and stores the space transfer function in the space transfer database.

5. The sound processing system of claim 4, wherein the second audio data includes a second X channel data, a second Y channel data, a second Z channel data, and a second W channel data.

6. The sound processing system of claim 5, wherein the parameter variations comprises a difference between the first X channel data and the second X channel data, a difference between the first Y channel data and the second Y channel data, a difference between the first Z channel data and the second Z channel data, and a difference between the first W channel data and the second W channel data.

7. A sound processing method, suitable for application in ambisonic format, comprising:
obtaining first audio data of a specific object corresponding to a first position;
when the specific object moves to a second position, calculating movement information of the specific object according to the first position and the second position;
generating a space transfer function corresponding to the movement information; and
storing the space transfer function to a space transfer database based on the first audio data.

8. The sound processing method of claim 7, further comprising:
recording the first audio data in the first position by a microphone array;
wherein the first audio data includes first X channel data, first Y channel data, first Z channel data, and a first W channel data, and the movement information includes a moving distance or a coordinate position.

9. The sound processing method of claim 7, further comprising:
searching the space transfer database for the space transfer function that corresponds to the movement information; and
applying the space transfer function to the first audio data, such that the processor adjusts the phase, the loudness or the frequency of the first audio data to generate the sound output of the specific object that corresponds to the second position.

10. The sound processing method of claim 7, further comprising:
calculating a plurality of parameter variations of the first audio data and a second audio data;
calculating the movement information of the first position and the second position;
generating the space transfer function corresponding to the movement information according to the parameter variations; and
storing the space transfer function in the space transfer database.
